(19) United States
(12) Patent Application Publication
(10) Pub. No.: US 2026/0074116 A1
(43) Pub. Date: Mar. 12, 2026

(54) SUBSTRATE-EQUIPPED MULTILAYER CERAMIC CAPACITOR

(71) Applicant: Murata Manufacturing Co., Ltd., Nagaokakyo-shi (JP)

(72) Inventor: Natsuko OKUBO, Nagaokakyo-shi (JP)

(21) Appl. No.: 19/245,640

(22) Filed: Jun. 23, 2025

(30) Foreign Application Priority Data
Sep. 6, 2024 (JP) 2024-154049

(51) Int. Cl. H01G 4/228; H01G 4/30

(52) U.S. Cl. CPC H01G 4/228; H01G 4/30

(57) ABSTRACT

A substrate-equipped multilayer ceramic capacitor includes a multilayer ceramic capacitor and a substrate. A dimension in a second direction of a portion of a first external electrode overlapping with a first surface as viewed in a lamination direction is smaller than a dimension in the second direction of a portion of the first external electrode overlapping with a second surface as viewed in the lamination direction. The first surface and the second surface are located on opposite sides with a first substrate surface interposed therebetween.

### CROSS REFERENCE TO RELATED APPLICATIONS

This application is based on and claims the benefit of priority from Japanese Patent Application No. 2024-154049, filed on Sep. 6, 2024, the entire contents of which are incorporated herein by reference.

### BACKGROUND OF THE INVENTION

### 1. Field of the Invention

The present invention relates to substrate-equipped multilayer ceramic capacitors.

### 2. Description of the Related Art

In the prior art, a structure including a multilayer ceramic capacitor and a substrate connected to the multilayer ceramic capacitor (referred to as a “substrate-equipped multilayer ceramic capacitor”) is known. For example, Japanese Unexamined Patent Application, Publication No. 2014-086606 discloses a structure in which a pair of external electrodes provided on a multilayer ceramic capacitor are connected to a pair of lands provided on a substrate by soldering.

Accompanying a reduction in size or thickness of electronic equipment, it is required to reduce the height of the multilayer ceramic capacitor together with the substrate. In addition, it is required to increase the capacitance of the multilayer ceramic capacitor.

As for the multilayer ceramic capacitor, for example, a high capacitance can be achieved by increasing the number of laminated dielectric ceramic layers and internal electrodes. However, when the number of laminated dielectric ceramic layers and internal electrodes increases, the height of the multilayer ceramic capacitor may increase.

### SUMMARY OF THE INVENTION

Example embodiments of the present invention provide substrate-equipped multilayer ceramic capacitors that are each able to achieve a reduction in height while achieving a high capacitance.

An example embodiment of the present invention provides a substrate-equipped multilayer ceramic capacitor which includes a multilayer ceramic capacitor, and a substrate. The multilayer ceramic capacitor includes a multilayer body including an inner layer portion including a plurality of dielectric layers and a plurality of internal electrodes that are alternately laminated, a first surface and a second surface opposed to each other and each extending in parallel or substantially parallel with a lamination direction, a third surface and a fourth surface opposed to each other and each extending in a first direction orthogonal or substantially orthogonal to the lamination direction, and a fifth surface and a sixth surface opposed to each other and each extending in a second direction orthogonal or substantially orthogonal to the lamination direction and the first direction, a first external electrode on the third surface and extending on the first surface, the second surface, the fifth surface, and the sixth surface, a second external electrode on the fourth surface and extending on the first surface, the second surface, the fifth surface, and the sixth surface. The substrate includes a first substrate surface and a second substrate surface opposed to each other in the lamination direction and on which the multilayer ceramic capacitor is mounted. A dimension in the second direction of a portion of the first external electrode overlapping with the first surface as viewed in the lamination direction is smaller than a dimension in the second direction of a portion of the first external electrode overlapping with the second surface as viewed in the lamination direction, a dimension in the second direction of a portion of the second external electrode overlapping with the first surface as viewed in the lamination direction is smaller than a dimension in the second direction of a portion of the second external electrode overlapping with the second surface as viewed in the lamination direction, and the first surface and the second surface are located on opposite sides of the first substrate surface.

According to example embodiments of the present invention, substrate-equipped multilayer ceramic capacitors that are each able to achieve a reduction in height while achieving a high capacitance are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a substrate-equipped multilayer ceramic capacitor according to a first example embodiment of the present invention.

FIG. 2 is a schematic perspective view of the multilayer ceramic capacitor according to the first example embodiment of the present invention.

FIG. 3 is a cross-sectional view taken along the line III-III in FIG. 1.

FIG. 4 is a cross-sectional view taken along the line IV-IV in FIG. 1.

FIG. 5 is a cross-sectional view taken along the line V-V in FIG. 1.

FIG. 6 is a schematic perspective view of the substrate according to the first example embodiment of the present invention.

FIG. 7 is a plan view of the substrate in the Z direction.

FIG. 8 is a view of a substrate-equipped multilayer ceramic capacitor according to a second example embodiment of the present invention and corresponds to FIG. 4.

### DETAILED DESCRIPTION OF THE EXAMPLE EMBODIMENTS

Example embodiments of the present invention will be described in detail below with reference to the drawings.

### First Example Embodiment

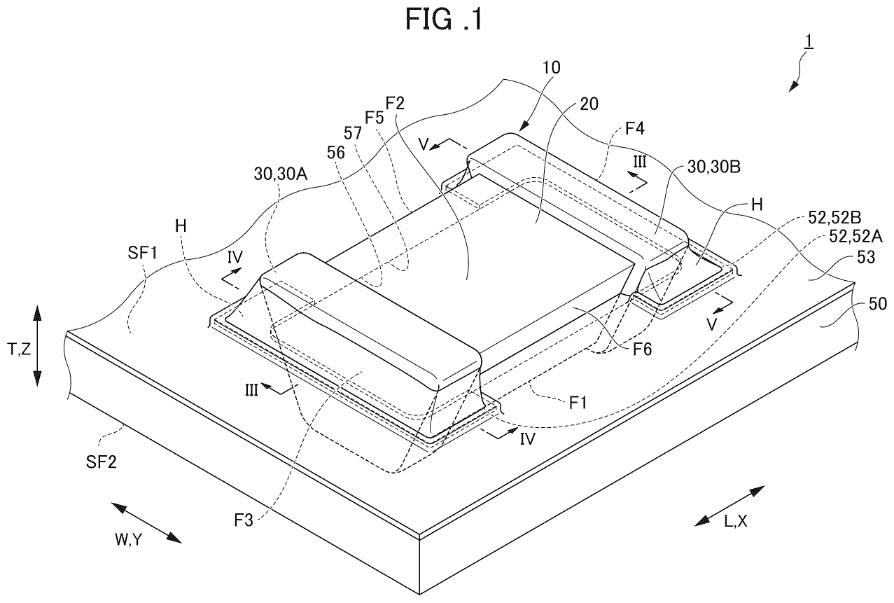

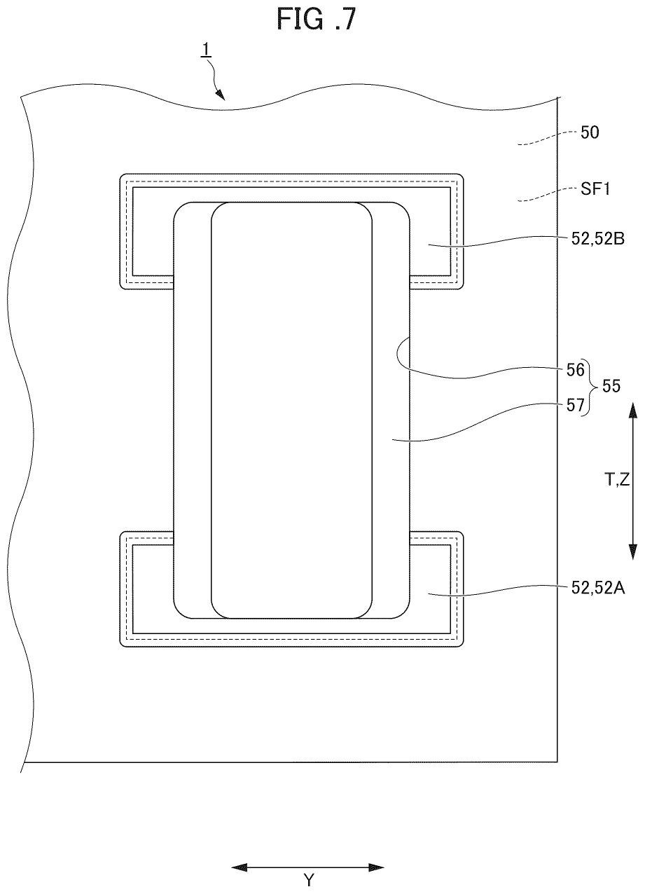

Hereinafter, a substrate-equipped multilayer ceramic capacitor 1 according to a first example embodiment of the present invention will be described with reference to FIGS. 1 to 7.

As shown in FIG. 1, the substrate-equipped multilayer ceramic capacitor 1 includes a multilayer ceramic capacitor 10, a substrate 50, a pair of lands 52, and a bonding material H. One substrate-equipped multilayer ceramic capacitor 1 includes, for example, one multilayer ceramic capacitor 10. In the substrate-equipped multilayer ceramic capacitor 1, for example, electronic components other than the multilayer ceramic capacitor 10 are not provided.

### Multilayer Ceramic Capacitor

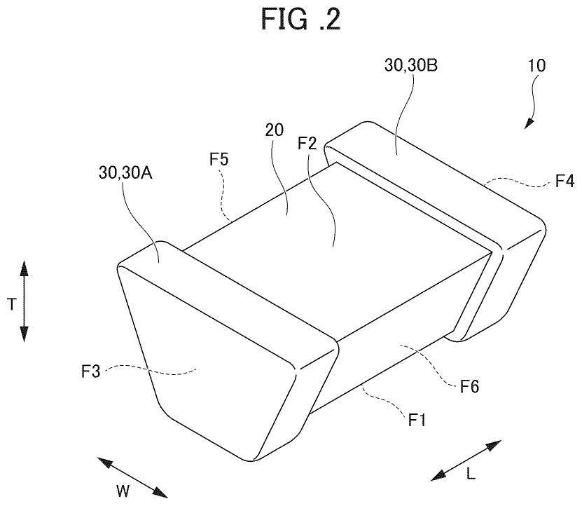

As shown in FIG. 2, the multilayer ceramic capacitor 10 has, for example, a quadrangular or substantially quadrangular columnar shape as a whole. The multilayer ceramic capacitor 10 includes a multilayer body 20, a first external electrode 30A, and a second external electrode 30B. The multilayer body includes an inner layer portion 21 including a plurality of dielectric layers 24 and a plurality of internal electrodes 25 alternately laminated. The first external electrode 30A and the second external electrode 30B may be collectively referred to as an “external electrode 30”.

In the present specification, a direction in which the dielectric layer 24 and the internal electrode 25 are laminated is referred to as a “lamination direction T”. A direction orthogonal or substantially orthogonal to the lamination direction T is referred to as a “first direction L”. A direction orthogonal or substantially orthogonal to the lamination direction T and the first direction L is referred to as a “second direction W”.

A dimension of the multilayer ceramic capacitor 10 in the first direction L is, for example, about 0.2 mm or more and about 3.2 mm or less. A dimension of the multilayer ceramic capacitor 10 in the second direction W is, for example, about 0.10 mm or more and about 1.60 mm or less. A dimension of the multilayer ceramic capacitor 10 in the lamination direction T is, for example, about 0.10 mm or more and about 1.60 mm or less. However, the outer dimensions of the multilayer ceramic capacitor 10 are not limited thereto.

### Multilayer Body

The multilayer body 20 has, for example, a quadrangular or substantially quadrangular columnar shape. The multilayer body 20 includes a first surface F1 and a second surface F2 opposed to each other in the lamination direction T, a third surface F3 and a fourth surface F4 opposed to each other in the first direction L, and a fifth surface F5 and a sixth surface F6 opposed to each other in the second direction W.

The third surface F3 is a portion of the outer surface of the multilayer body 20 surrounded by the outer contour line of the multilayer body 20 when only the multilayer body 20 is viewed from one side in the first direction L. The fourth surface F4 is a portion of the outer surface of the multilayer body 20 surrounded by the outer contour line of the multilayer body 20 when only the multilayer body 20 is viewed from the other side in the first direction L.

The fifth surface F5 is a portion of the outer surface of the multilayer body 20 surrounded by the outer contour line of the multilayer body 20 when only the multilayer body 20 is viewed from one side in the second direction W, and does not correspond to either of the third surface F3 or the fourth surface F4. The sixth surface F6 is a portion of the outer surface of the multilayer body 20 surrounded by the outer contour line of the multilayer body 20 when only the multilayer body 20 is viewed from the other side in the second direction W, and does not correspond to either of the third surface F3 or the fourth surface F4.

The first surface F1 is a portion of the outer surface of the multilayer body 20 surrounded by the outer contour line of the multilayer body 20 when only the multilayer body 20 is viewed from one side in the lamination direction T, and does not correspond to any of the third surface F3, the fourth surface F4, the fifth surface F5, and the sixth surface F6. The second surface F2 is a portion of the outer surface of the multilayer body 20 surrounded by the outer contour line of the multilayer body 20 when only the multilayer body 20 is viewed from the other side in the lamination direction T, and does not correspond to any of the third surface F3, the fourth surface F4, the fifth surface F5, and the sixth surface F6.

The multilayer body 20 includes an inner layer portion 21 and a pair of outer layer portions 22 that sandwich the inner layer portion 21 in the lamination direction T. Portions of the multilayer body 20 where the three outer surfaces intersect with each other are each referred to as a “corner portion”. Portions of the multilayer body 20 where two outer surfaces intersect with each other are each referred to as a “ridge portion”. The corner portions and the ridge portions of the multilayer body 20 may be rounded.

### Inner Layer Portion

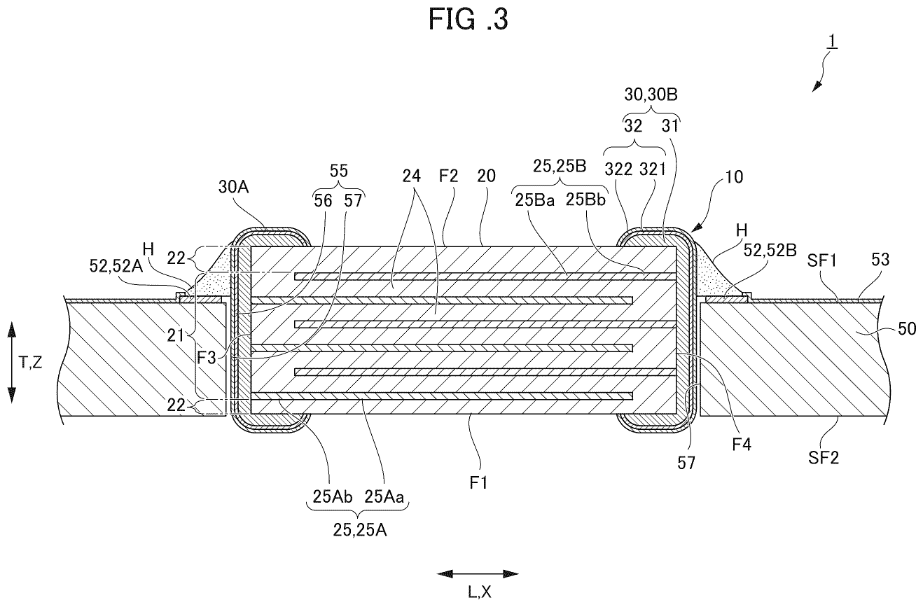

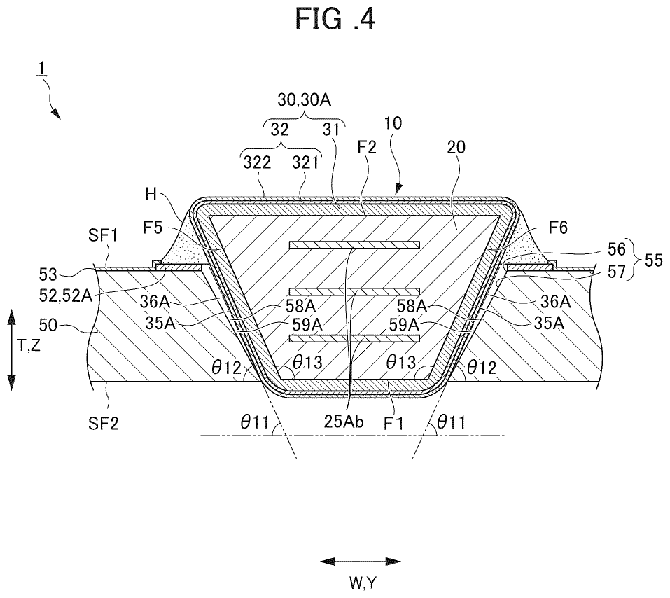

As shown in FIGS. 3 and 4, the inner layer portion 21 includes a plurality of dielectric layers 24 and a plurality of internal electrodes 25. The dielectric layers 24 and the internal electrodes 25 are alternately laminated.

The dielectric layer 24 preferably includes, for example, a perovskite compound such as BaTiO₃, CaTiO₃, SrTiO₃, or CaZrO₃ as a main component. Since each of the dielectric layers 24 is made of a high dielectric constant material such as BaTiO₃, it is possible to increase the capacitance of the multilayer ceramic capacitor 10. In each of the dielectric layers 24, for example, a Mn compound, a Mg compound, a Si compound, a Fe compound, a Cr compound, a Co compound, a Ni compound, an Al compound, a V compound, a rare earth compound, or the like may be added as a subcomponent to these main components.

Each of the internal electrodes 25 is formed by, for example, sintering an electrically conductive paste including a metal powder defining and functioning as an electrical conductor, an organic solvent, a binder, and a dispersant on a corresponding one of the dielectric layers 24. As the metal powder defining and functioning as an electrical conductor, for example, a metal such as Ni, Cu, Ag, Pd, an Ag—Pd alloy, Au, or Sn is used. These metals may be compounds including these metal elements or may be alloys with other metals. The main component of each of the internal electrodes 25 is, for example, preferably Ni. However, the main component of each of the internal electrodes 25 is not limited thereto. A solid solution layer of, for example, Sn may be formed at the interface between the internal electrodes 25 and the dielectric layers 24. As a result, electric field concentration at the interface between the internal electrodes 25 and the dielectric layers 24 can be relaxed. The amount of deviation in the second direction W among the end portions of the internal electrodes 25 adjacent to one another in the lamination direction T is, for example, preferably about 1.0 μm or less. With such a configuration, it is possible to increase the area where the internal electrodes 25 are opposed to each other, such that it is possible to increase the capacitance.

The internal electrodes 25 include a plurality of first internal electrodes 25A and a plurality of second internal electrodes 25B. The first internal electrodes 25A are exposed only on the third surface F3. The second internal electrodes 25B are exposed only on the fourth surface F4. The first internal electrodes 25A and the second internal electrodes 25B are alternately provided.

Each of the first internal electrodes 25A includes a first counter portion 25Aa and a first extension portion 25Ab. The first counter portion 25Aa is a portion of the first internal electrode 25A opposed to the adjacent second internal electrode 25B. The first extension portion 25Ab is a portion of the first internal electrode 25A which extends from the first counter portion 25Aa toward the third surface F3.

Each of the second internal electrodes 25B includes a second counter portion 25Ba and a second extension portion 25Bb. The second counter portion 25Ba is a portion of the second internal electrode 25B opposed to the adjacent first internal electrode 25A (the first counter portion 25Aa). The second extension portion 25Bb is a portion of the second internal electrode 25B which extends from the second counter portion 25Ba toward the fourth surface F4. Since the first counter portion 25Aa and the second counter portion 25Ba are opposed to each other, a capacitance of the multilayer ceramic capacitor 10 can be generated.

### Outer Layer Portion

The outer layer portion 22 is made of the same material as the dielectric layers 24 of the inner layer portion 21. The internal electrode 25 is not provided in the outer layer portion 22.

### External Electrode

The first external electrode 30A is provided on the third surface F3, specifically, provided on the third surface F3, the first surface F1, the second surface F2, the fifth surface F5, and the sixth surface F6. The first external electrode 30A is connected to the first internal electrodes 25A.

The second external electrode 30B is provided on the fourth surface F4. More specifically, the second external electrode 30B is provided on the fourth surface F4, the first surface F1, the second surface F2, the fifth surface F5, and the sixth surface F6. The second external electrode 30B is connected to the second internal electrodes 25B.

Each of the external electrodes 30 includes a base electrode layer 31 provided on the outer surface of the multilayer body 20 and a plated layer 32 provided on the base electrode layer 31.

The base electrode layer 31 is, for example, a fired layer including an electrically conductive metal and glass. The electrically conductive metal is, for example, a metal such as Ni, Cu, Ag, Pd, Au, or an Ag—Pd alloy, and is preferably Cu.

The plated layer 32 is made of, for example, one metal of Ni, Cu, Ag, Pd, Au, or Sn, or an alloy including the metal. The plated layer 32 includes, for example, a first plated layer 321 provided on the base electrode layer 31 and a second plated layer 322 provided on the first plated layer 321. The first plated layer 321 is, for example, a Ni plated layer. The second plated layer 322 is, for example, a Sn plated layer. The plated layer 32 may include a single-layer configuration.

In addition, a portion of each of the external electrodes 30 that overlaps the first surface F1 when viewed in the direction from the first surface F1 toward the second surface F2 in the lamination direction T and that is located on the outer side (near side) of the first surface F1 is referred to as a “portion of the external electrode 30 that is provided on the first surface F1”. A portion of the external electrode 30 that overlaps the second surface F2 when viewed in the direction from the second surface F2 toward the first surface F1 in the lamination direction T and that is located on the outer side of the second surface F2 is referred to as a “portion of the external electrode 30 that is provided on the second surface F2”.

A portion of the external electrode 30 that overlaps the third surface F3 when viewed in the direction from the third surface F3 to the fourth surface F4 in the first direction L and that is located on the outer side of the third surface F3 is referred to as a “portion of the external electrode 30 that is provided on the third surface F3”. A portion of the external electrode 30 that overlaps the fourth surface F4 when viewed in the direction from the fourth surface F4 toward the third surface F3 in the first direction L and that is located on the outer side of the fourth surface F4 is referred to as a “portion of the external electrode 30 that is provided on the fourth surface F4”.

A portion of the external electrode 30 that overlaps the fifth surface F5 when viewed in the direction from the fifth surface F5 toward the sixth surface F6 in the second direction W and that is located on the outer side of the fifth surface F5 is referred to as a “portion of the external electrode 30 that is provided on the fifth surface F5”. A portion of the external electrode 30 that overlaps the sixth surface F6 when viewed in the direction from the sixth surface F6 toward the fifth surface F5 in the second direction W and that is located on the outer side of the sixth surface F6 is referred to as a “portion of the external electrode 30 that is provided on the sixth surface F6”.

### Substrate

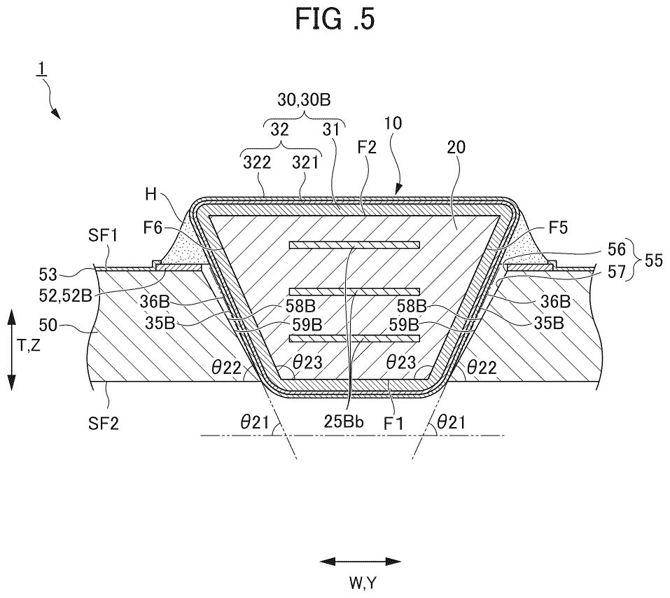

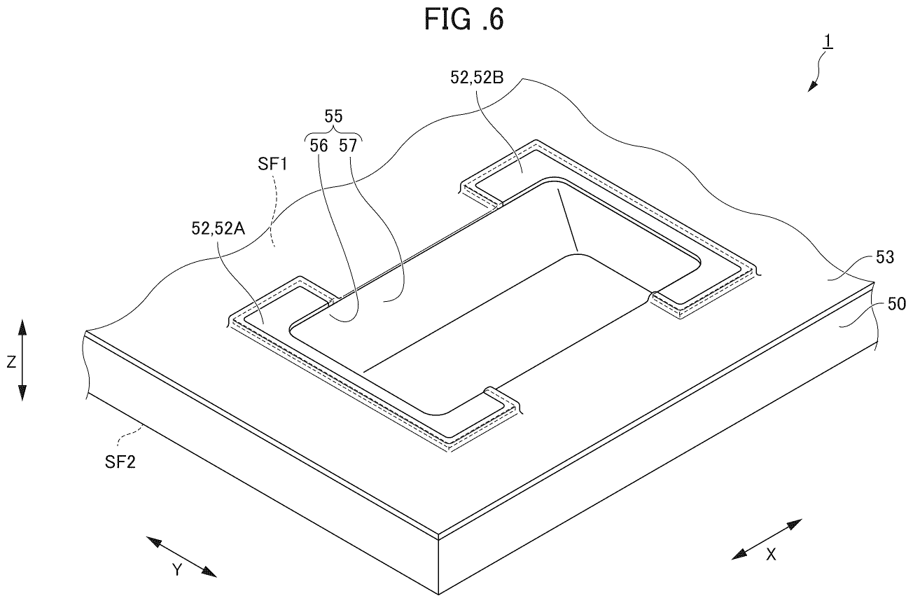

As shown in FIGS. 5 and 6, the substrate 50 is made of an insulating material such as, for example, resin, glass, glass epoxy, paper phenol, or ceramics. The substrate 50 is made of, for example, a material obtained by impregnating a base material obtained by mixing a glass cloth and a glass nonwoven fabric with an epoxy resin, a polyimide resin, or the like, or a ceramic substrate manufactured by firing a sheet obtained by mixing ceramics and glass. The substrate 50 has a flat plate shape. The thickness of the substrate 50 (that is, the dimension in the Z direction described later) is, for example, preferably about 0.5 mm or more and about 2.0 mm or less. The substrate 50 may be a single-layer plate-shaped body or a plate-shaped body including a plurality of layers. The substrate 50 includes a first substrate surface SF1 and a second substrate surface SF2 opposed to each other.

### Land

Each of the lands 52 is a terminal connected to a corresponding one of the external electrodes 30. The lands 52 are provided on the first substrate surface SF1 at intervals. Wiring (not shown) is connected to each land 52. Each land 52 and each wiring are formed by, for example, depositing a highly electrically conductive metal such as Cu or Ag on the first substrate surface SF1. Each land 52 includes a first land 52A connected to the first external electrode 30A and a second land 52B connected to the second external electrode 30B.

Further, an insulating film 53 is provided on the first substrate surface SF1. The insulating film 53 covers, for example, a portion of the first substrate surface SF1 where the lands 52 are not provided and the peripheral portions of the lands 52. At least a portion of the first land 52A is not covered with the insulating film 53. At least a portion of the second land 52B is not covered with the insulating film 53.

### Bonding Material

The bonding material H bonds the multilayer ceramic capacitor 10 to the land 52. The bonding material H is, for example, solder. The bonding material H is provided on each of the first land 52A and the second land 52B. The first external electrode 30A and the first land 52A are bonded to each other by the bonding material H. The second external electrode 30B and the second land 52B are bonded by the bonding material H. Thus, the multilayer ceramic capacitor 10 is mounted on the substrate 50.

The direction in which the lands 52 are aligned among the directions parallel or substantially parallel to the first substrate surface SF1 is referred to as an “X direction”. A direction orthogonal or substantially orthogonal to the X direction among directions parallel or substantially parallel to the first substrate surface SF1 is referred to as a “Y direction”. A direction orthogonal or substantially orthogonal to the direction in which the first substrate surface SF1 extends is referred to as a “Z direction”.

Further, the multilayer ceramic capacitor 10 is mounted on the substrate 50 in a direction in which the lamination direction T and the Z direction are parallel or substantially parallel to each other. The multilayer ceramic capacitor 10 is mounted on the substrate 50 in a direction in which a direction viewed from the second surface F2 to the first surface F1 is the same or substantially same as a direction viewed from the first substrate surface SF1 to the second substrate surface SF2. The first direction L and the X direction coincide with each other. The second direction W and the Y direction coincide with each other. The lamination direction T and the Z direction coincide with each other. The direction in which the first substrate surface SF1 and the second substrate surface SF2 are opposed to each other is the lamination direction T.

Here, the substrate 50 includes an opening portion 55 including an opening 56 that is open on the first substrate surface SF1 and an inner peripheral surface 57.

The opening portion 55 is a portion into which the multilayer ceramic capacitor 10 is inserted. The opening portion 55 has either a bottomed recessed shape that is open on the first substrate surface SF1 or a hole shape that penetrates the substrate 50 in the Z direction, and more specifically, has a hole shape that penetrates the substrate 50 in the Z direction.

The shape of the opening 56 as viewed in the Z direction is, for example, a rectangular or substantially rectangular shape whose longitudinal direction is the X direction.

In a cross-sectional view parallel or substantially parallel to the X direction and the Z direction, portions of the inner peripheral surface 57 that are opposed to each other in the X direction extend parallel or substantially parallel to the Z direction, for example. In a cross-sectional view parallel or substantially parallel to the X direction and the Z direction, the internal space of the opening portion 55 has, for example, a rectangular or substantially rectangular shape.

In a cross-sectional view parallel or substantially parallel to the Y direction and the Z direction, each of the portions of the inner peripheral surface 57 opposed to each other in the Y direction is sloped so as to approach the middle portion of the opening portion 55 in the X direction approaching the second substrate surface SF2 from the first substrate surface SF1, for example. In a cross-sectional view parallel or substantially parallel to the Y direction and the Z direction, the internal space of the opening portion 55 has, for example, a trapezoidal or substantially trapezoidal shape that tapers approaching the second substrate surface SF2 from the first substrate surface SF1.

In addition, for example, the lands 52 are provided on the first substrate surface SF1 and sandwich the opening 56 in the X direction. The first land 52A extends, for example, along one side in the X direction of the paired sides in the X direction of the opening 56 and an end portion on one side in the X direction of each of the paired sides in the Y direction of the opening 56. The shape of the first land 52A as viewed in the Z direction is, for example, a U-shape or substantially a U-shape that is open toward the middle portion of the opening portion 55 in the X direction. The second land 52B extends, for example, along the other side in the X direction of the paired sides in the X direction of the opening 56 and an end portion on the other side in the X direction of each of the paired sides in the Y direction of the opening 56. The shape of the second land 52B as viewed in the Z direction is, for example, a U-shape or substantially a U-shape that is open toward the middle portion of the opening portion 55 in the X direction.

A dimension in the second direction W of a portion of the first external electrode 30A provided on the first surface F1 is smaller than a dimension in the second direction W of a portion of the first external electrode 30A provided on the second surface F2. The shape of the first external electrode 30A as viewed in the first direction L is, for example, a trapezoidal or substantially trapezoidal shape that tapers approaching from the second surface F2 toward the first surface F1.

A dimension in the second direction W of a portion of the second external electrode 30B provided on the first surface F1 is smaller than a dimension in the second direction W of a portion of the second external electrode 30B provided on the second surface F2. The second external electrode 30B has, for example, a trapezoidal or substantially trapezoidal shape that tapers approaching from the second surface F2 toward the first surface F1 when viewed in the first direction L.

The shape of the multilayer body 20 as viewed in the first direction L is, for example, a trapezoidal or substantially trapezoidal shape that tapers approaching from the second surface F2 toward the first surface F1. The shape of the multilayer body 20 is, for example, a quadrangular or substantially quadrangular columnar shape having a trapezoidal or substantially trapezoidal bottom surface in which the length of the upper base is different from the length of the lower base.

The multilayer ceramic capacitor 10 is placed in the opening portion 55. The first surface F1 and the second surface F2 are located on opposite sides interposing the first substrate surface SF1. The first surface F1 is located, for example, between the first substrate surface SF1 and the second substrate surface SF2.

The shortest distance between the first substrate surface SF1 and the first surface F1 is smaller than, for example, the shortest distance between the first substrate surface SF1 and the second surface F2. The position of the first surface F1 in the Z direction and the position of the second substrate surface SF2 in the Z direction are the same or substantially the same, for example. The first external electrode 30A penetrates the substrate 50 in the Z direction. The second external electrode 30B penetrates the substrate 50 in the Z direction.

Portions of the first external electrode 30A and the second external electrode 30B provided on the fifth surface F5 are in contact with the substrate 50, and portions of the first external electrode 30A and the second external electrode 30B provided on the sixth surface F6 are in contact with the substrate 50.

For example, a portion of the first external electrode 30A provided on the fifth surface F5 is in contact with the substrate 50 (specifically, the inner peripheral surface 57), and a portion of the first external electrode 30A provided on the sixth surface F6 is in contact with the substrate 50 (specifically, the inner peripheral surface 57).

It is preferable that a portion of the first external electrode 30A overlapping the multilayer body 20 when viewed in the first direction L (in other words, a portion of the first external electrode 30A that is provided on the third surface F3) is not in contact with the substrate 50. With such a configuration, it is possible to reduce or prevent the transmission of stress from the substrate to the multilayer body.

The multilayer body 20 and the substrate 50 are preferably not in contact with each other. With such a configuration, it is possible to reduce or prevent the transmission of stress from the substrate to the multilayer body. However, the present invention is not limited thereto, and a portion of the first external electrode 30A overlapping the multilayer body 20 when viewed in the first direction L may be in contact with the substrate 50, or the multilayer body 20 may be in contact with the substrate 50.

In a state in which the multilayer ceramic capacitor 10 is mounted on the substrate 50, for example, when the second plated layer 322 is a Sn plated layer and the bonding material H is solder, the second plated layer 322 and the bonding material H are integrated with each other, which may make it difficult to determine the boundary between the external electrode 30 and the bonding material H. In this case, when the shortest distance between the first plated layer 321 and the substrate 50 is equal to or less than the thickness of the first plated layer 321, the external electrode 30 and the substrate 50 are considered to be in contact with each other.

The multilayer ceramic capacitor 10 includes capacitor-side counter surfaces 35 opposed to the inner peripheral surface 57 of the opening portion 55 in the Z direction, and the inner peripheral surface 57 of the opening portion 55 includes substrate-side counter surfaces 58 opposed to the capacitor-side counter surfaces 35 in the Z direction.

For example, the first external electrode 30A includes first capacitor-side counter surfaces 35A opposed to the inner peripheral surface 57 in the Z direction, and the inner peripheral surface 57 includes first substrate-side counter surfaces 58A opposed to the first capacitor-side counter surfaces 35A in the Z direction.

The first capacitor-side counter surfaces 35A are respectively provided on a portion of the first external electrode 30A provided on the fifth surface F5 and a portion of the first external electrode 30A provided on the sixth surface F6.

The first substrate-side counter surfaces 58A are provided on each of the portions of the inner peripheral surface 57 opposed in the Y direction.

In a cross section (referred to as “WT cross section”) parallel or substantially parallel to the second direction W and the lamination direction T of the substrate-equipped multilayer ceramic capacitor 1, the capacitor-side counter surfaces 35 include capacitor-side sloped surfaces 36 which are sloped with respect to the lamination direction T and the second direction W, and the substrate-side counter surfaces 58 include substrate-side sloped surfaces 59 which are sloped with respect to the lamination direction T and the second direction W.

For example, in the WT cross section passing through the middle portion of the first external electrode 30A in the first direction L, the first capacitor-side counter surface 35A includes the first capacitor-side sloped surface 36A which is sloped with respect to the lamination direction T and the second direction W, and the first substrate-side counter surface 58A includes the first substrate-side sloped surface 59A which is sloped with respect to the lamination direction T and the second direction W.

The entire or substantially the entire first capacitor-side counter surface 35A is, for example, the first capacitor-side counter surface 36A. The entire or substantially the entire first substrate-side counter surface 58A is, for example, the first substrate-side sloped surface 59A.

In the WT cross section, the acute angle between the capacitor-side sloped surface 36 and the second direction W is more obtuse than the acute angle between the substrate-side sloped surface 59 and the second direction W.

For example, in a WT cross section passing through a middle portion of the first external electrode 30A in the first direction L, an acute angle (referred to as “θ11”) between the first capacitor-side sloped surface 36A and the second direction W is more obtuse than an acute angle (referred to as “θ12”) between the first substrate-side sloped surface 59A and the second direction W.

In the WT cross section, the obtuse angle between the capacitor-side sloped surface 36 and the portion of the external electrode 30 provided on the first surface F1 is, for example, preferably about 110° or more and about 135° or less.

For example, in a WT cross section passing through a middle portion of the first external electrode 30A in the first direction L, an obtuse angle (referred to as “θ13”) between a portion of the first external electrode 30A provided on the first surface F1 and the first capacitor-side sloped surface 36A is, for example, preferably about 110° or more and about 135° or less. The obtuse angle between the first surface F1 and the first capacitor-side sloped surface 36A is, for example, preferably about 110° or more and about 135° or less.

In the WT cross section, the acute angle between the capacitor-side sloped surface 36 and the second direction W is, for example, preferably about 45° or more and about 70° or less, and the angle obtained by subtracting the acute angle between the substrate-side sloped surface 59 and the second direction W from the acute angle between the capacitor-side sloped surface 36 and the second direction W is, for example, preferably greater than about 0° and about 5° or less.

For example, in the WT cross section passing through the middle portion of the first external electrode 30A in the first direction L, the acute angle θ11 between the first capacitor-side sloped surface 36A and the second direction W is, for example, preferably about 45° or more and about 70° or less, and the angle obtained by subtracting the acute angle θ12 between the first substrate-side sloped surface 59A and the second direction W from the acute angle θ11 between the first capacitor-side sloped surface 36A and the second direction W is, for example, preferably greater than about 0° and about 5° or less.

The portion of the external electrode 30 provided on the first surface F1 and the substrate 50 are separated from each other.

For example, a portion of the first external electrode 30A provided on the first surface F1 and the substrate 50 are separated from each other. The entire or substantially the entire first surface F1 overlaps the internal space of the opening portion 55 when viewed in the lamination direction T.

Further, a portion of the second external electrode 30B provided on the fifth surface F5 is in contact with the substrate 50 (specifically, the inner peripheral surface 57), and a portion of the second external electrode 30B provided on the sixth surface F6 is in contact with the substrate 50 (specifically, the inner peripheral surface 57).

The portion of the second external electrode 30B provided on the fourth surface F4 is preferably not in contact with the substrate 50. With such a configuration, it is possible to reduce or prevent the transmission of stress from the substrate to the multilayer body.

The second external electrode 30B includes second capacitor-side counter surfaces 35B that are opposed to the inner peripheral surface 57 in a direction orthogonal or substantially orthogonal to the first substrate surface SF1. The inner peripheral surface 57 includes second substrate-side counter surfaces 58B opposed to the second capacitor-side counter surfaces 35B in a direction orthogonal or substantially orthogonal to the first substrate surface SF1.

For example, in the WT cross section passing through the middle portion of the second external electrode 30B in the first direction L, the second capacitor-side counter surfaces 35B include second capacitor-side sloped surfaces 36B which are sloped with respect to the lamination direction T and the second direction W. The entire or substantially the entire second capacitor-side counter surface 35B is, for example, the second capacitor-side counter surface 36B.

The second substrate-side counter surfaces 58B include second substrate-side sloped surfaces 59B which are sloped with respect to the lamination direction T and the second direction W. The entire or substantially the entire second substrate-side counter surface 58B is, for example, the second substrate-side sloped surface 59A.

In the WT cross section passing through the middle portion of the second external electrode 30B in the first direction L, the acute angle (defined as “θ21”) between the second capacitor-side sloped surface 36B and the second direction W is more obtuse than the acute angle (defined as “θ22”) between the second substrate-side sloped surface 59B and the second direction W.

In the WT cross section passing through the middle portion of the second external electrode 30B in the first direction L, an obtuse angle (referred to as “θ23”) between a portion of the second external electrode 30B provided on the first surface F1 and the second capacitor-side sloped surface 36B is, for example, preferably about 110° or more and about 135° or less. In addition, the obtuse angle between the second surface F2 and the second capacitor-side sloped surface 36B is, for example, preferably about 110° or more and about 135° or less.

In the WT cross section passing through the middle portion of the second external electrode 30B in the first direction L, the acute angle θ21 between the second capacitor-side sloped surface 36B and the second direction W is, for example, preferably about 45° or more and about 70° or less, and an angle obtained by subtracting the acute angle θ22 between the second substrate-side sloped surface 59B and the second direction W from the acute angle θ21 between the second capacitor-side sloped surface 36B and the second direction W is, for example, preferably greater than about 0° and about 5° or less.

The portion of the second external electrode 30B provided on the first surface F1 and the substrate 50 are separated from each other.

In addition, the first capacitor-side counter surface 35A and the second capacitor-side counter surface 35B correspond to the capacitor-side counter surfaces 35, respectively. The first capacitor-side sloped surface 36A and the second capacitor-side sloped surface 36B correspond to the capacitor-side sloped surfaces 36, respectively. The first substrate-side counter surface 58A and the second substrate-side counter surface 58B correspond to the substrate-side counter surfaces 58, respectively. The first substrate-side sloped surface 59A and the second substrate-side sloped surface 59B correspond to the substrate-side sloped surface 59, respectively.

Each cross section of the substrate-equipped multilayer ceramic capacitor 1 is exposed by polishing, for example. The dimension and the angle of each of the portions are measured by observing the cross section in the exposed state with an electron microscope.

### Manufacturing Method of Multilayer Ceramic Capacitor 10

Next, an example of a method of manufacturing the multilayer ceramic capacitor 10 according to the present example embodiment will be described.

### Internal Electrode Pattern Forming Step

First, a ceramic green sheet in which a ceramic slurry is formed into a sheet shape is prepared. The ceramic green sheet includes a binder, a solvent, and the like in addition to a ceramic raw material including a dielectric ceramic material. In addition, an additive including a rare earth element may be added to the ceramic raw material. A pattern of the internal electrodes 25 (may be simply referred to as an “internal electrode pattern”) is printed on the ceramic green sheet with an electrically conductive paste. The shape of each of the internal electrode patterns as viewed in the lamination direction T is, for example, rectangular or substantially rectangular. Thus, a ceramic green sheet for manufacturing an inner layer portion in which the internal electrodes 25 are provided is obtained. The internal electrode pattern is formed by, for example, screen printing, gravure printing, relief printing, or the like.

### Laminating Process

Next, the ceramic green sheets for manufacturing the inner layer portion are laminated. The ceramic green sheets for manufacturing the inner layer portion are laminated such that the internal electrode patterns are shifted by about a half pitch in the length direction L between the adjacent sheets. Next, the ceramic green sheets for the outer layer portions to be the outer layer portions 22 are laminated on both sides of the laminated ceramic green sheets for the inner layer portion in the lamination direction T. The ceramic green sheets for the outer layer portions are, for example, thermocompression-bonded to the ceramic green sheet. A mother block is thus obtained. The mother block is pressed in the lamination direction T by, for example, isostatic pressing or the like.

Each of the outer layer portions 22 may include a plurality of laminated ceramic green sheets, or may include a single ceramic green sheet. The ceramic green sheets for the inner layer portion and the ceramic green sheets for the outer layer portions may contain different components.

### Mother Block Cutting Process

The mother block is then divided along cutting lines corresponding to the dimensions of the multilayer body. The mother block is cut using, for example, a cutting device including a cutting blade. The mother block is, for example, cut in the lamination direction T along the first direction L and cut in the lamination direction T along the second direction W. As a result, a plurality of rectangular or substantially rectangular parallelepiped blocks (referred to as “multilayer chips”) are obtained. The corner portions and ridge portions of each of the multilayer chips are preferably rounded by barrel polishing, for example.

When the mother block is cut in the lamination direction T along the first direction L, for example, the cutting blade is pushed into the mother block in a direction oblique to the lamination direction T and the second direction W. With such a configuration, in the mother block, the surface defining and functioning as the fifth surface F5 and the surface defining and functioning as the sixth surface F6 are formed obliquely with respect to the lamination direction T and the second direction W, respectively.

### Multilayer Body Firing Step

Next, each of the multilayer chips is heated at a predetermined firing temperature in a nitrogen atmosphere for a predetermined period of time. The multilayer body 20 is thus obtained. The sloped surfaces of the surface of the multilayer body 20 may be formed by, for example, polishing the outer surface of the multilayer body 20. In the cutting step, the mother block may not necessarily be cut obliquely with respect to the lamination direction T.

### Base Electrode Layer Forming Step

Next, the base electrode layer 31 is formed on each of the third surface F3 and the fourth surface F4 of the multilayer body 20. An electrically conductive paste including, for example, glass and metal is applied onto the multilayer body 20. For example, the base electrode layer 31 is formed so as to cover the whole of one of the third surface F3 or the fourth surface F4, a portion of the first surface F1 or the second surface F2, and a portion of the fifth surface F5 or the sixth surface F6. However, the present invention is not limited thereto, and the base electrode layer 31 may be provided only on the third surface F3. The base electrode layer 31 may be provided only on the fourth surface F4.

### Base Electrode Layer Firing Step

Next, the multilayer body 20 on which the base electrode layer 31 is formed is heated at a predetermined firing temperature for a predetermined time in a nitrogen atmosphere. As a result, the base electrode layer 31 is fired on the multilayer body 20. The multilayer body firing step and the base electrode layer firing step may be performed simultaneously after the material of the base electrode layer 31 is provided on the multilayer chip.

### Plating Step

Next, the plated layer 32 is formed on the base electrode layer 31. First, a first plated layer 321 is formed on the base electrode layer 31. Next, a second plated layer 322 is formed on the first plated layer 321. The first plated layer 321 is formed by, for example, Ni plating. The second plated layer 322 is formed by, for example, Sn plating. The first plated layer 321 and the second plated layer 322 are sequentially formed by, for example, an electrolytic plating method. The external electrode 30 is thus formed.

The shape of the external electrode 30 when viewed in the first direction L is the same or substantially same as the shape of the multilayer body 20 when viewed in the first direction L. Therefore, the surface of the portion of the external electrode 30 provided on the fifth surface F5 and the surface of the portion of the external electrode 30 provided on the sixth surface F6 are sloped with respect to the lamination direction T and the second direction.

However, the shape of the external electrode 30 as viewed in the first direction L can also be adjusted by adjusting the shape of the base electrode layer 31. The shape of the base electrode layer 31 can be adjusted by, for example, adjusting the shape of the electrically conductive paste with a blade or the like in the base electrode layer forming step, or polishing the base electrode layer 31 after firing. Therefore, the surface sloped with respect to the lamination direction T may not necessarily be formed on the surface of the multilayer body 20. The shape of the external electrode 30 as viewed in the first direction L may not be the same or substantially same as an analogous enlarged shape of the multilayer body 20 as viewed in the first direction L.

The multilayer ceramic capacitor 10 shown in FIG. 1 is thus obtained.

### Mounting Method of Multilayer Ceramic Capacitor 10

Next, an example of a method of mounting the multilayer ceramic capacitor 10 on the substrate 50 will be described. The multilayer ceramic capacitor 10 is mounted on the substrate 50 by soldering by reflow, for example.

Prior to soldering, the insulating film 53 is provided on the first substrate surface SF1. The insulating film 53 is provided at a portion of the first substrate surface SF1 where the lands 52 are not provided. The insulating film 53 may be provided on the inner peripheral surface 57 of the opening portion 55.

Next, for example, solder paste is prepared as the bonding material H. The solder paste is provided on the land 52. Next, the multilayer ceramic capacitor 10 is provided on the substrate 50. The multilayer ceramic capacitor 10 is inserted into the opening portion 55. The external electrode 30, the land 52, and the solder are in contact with or close to one another in the direction in which the first substrate surface SF1 extends. Next, the substrate 50 on which the multilayer ceramic capacitor 10 is provided is heated to the reflow temperature of the solder in a reflow furnace. As a result, the solder is melted, and the external electrode 30 and the land 52 are connected to each other.

Thus, the multilayer ceramic capacitor 10 is mounted on the substrate 50. The substrate-equipped multilayer ceramic capacitor 1 shown in FIG. 1 is obtained.

### Advantageous Effects of Example Embodiments

According to the present example embodiment, it is possible to obtain the following advantageous effects.

According to the present example embodiment, the substrate-equipped multilayer ceramic capacitor 1 includes the multilayer ceramic capacitor 10 and the substrate 50. The multilayer ceramic capacitor 10 includes the multilayer body 20 including the inner layer portion 21 including the plurality of dielectric layers 24 and the plurality of internal electrodes 25 that are alternately laminated, the first surface F1 and the second surface F2 opposed to each other and each extending in parallel or substantially parallel with the lamination direction T, the third surface F3 and the fourth surface F4 opposed to each other and each extending in the first direction L orthogonal or substantially orthogonal to the lamination direction T, and the fifth surface F5 and the sixth surface F6 opposed to each other and each extending in the second direction W orthogonal or substantially orthogonal to the lamination direction and the first direction, the first external electrode 30A provided on the third surface F3 and extending on the first surface F1, the second surface F2, the fifth surface F5, and the sixth surface F6, the second external electrode 30B provided on the fourth surface F4 and extending on the first surface F1, the second surface F2, the fifth surface F5, and the sixth surface F6. The substrate 50 includes the first substrate surface SF1 and the second substrate surface SF2 that are opposed to each other in the lamination direction and on which the multilayer ceramic capacitor is mounted. A dimension in the second direction W of a portion of the first external electrode 30A overlapping with the first surface F1 as viewed in the lamination direction T is smaller than a dimension in the second direction W of a portion of the first external electrode 30A overlapping with the second surface F2 as viewed in the lamination direction T. A dimension in the second direction W of a portion of the second external electrode 30B overlapping with the first surface F1 as viewed in the lamination direction T is smaller than a dimension in the second direction W of a portion of the second external electrode 30B overlapping with the second surface F2 as viewed in the lamination direction T. The first surface F1 and the second surface F2 are located on opposite sides interposing the first substrate surface SF1.

According to this configuration, since it is possible to embed the multilayer ceramic capacitor 10 in the substrate 50, it is possible to reduce the height of the substrate-equipped multilayer ceramic capacitor 1. Since it is possible to reduce the height of the substrate-equipped multilayer ceramic capacitor without reducing the height of the multilayer ceramic capacitor 10 itself, it is possible to reduce the height of the substrate-equipped multilayer ceramic capacitor 1 without reducing the number of laminated dielectric layers 24 and internal electrodes 25.

Therefore, it is possible to provide the substrate-equipped multilayer ceramic capacitor 1 that is able to achieve a reduction in height while achieving a high capacitance.

In addition, it is possible to allow the bonding material H to easily further extend to the portion of the external electrode 30 provided on the fifth surface F5 and the portion of the external electrode 30 provided on the sixth surface F6. It is possible to easily maintain the mounting posture of the multilayer ceramic capacitor 10.

According to the present example embodiment, a portion of the external electrode 30 provided on the fifth surface F5 (in other words, a portion of the external electrode 30 overlapping with the multilayer body 20 as viewed from one side in the second direction W) is in contact with the substrate 50, and a portion of the external electrode 30 provided on the sixth surface F6 (in other words, a portion of the external electrode 30 overlapping with the multilayer body 20 as viewed from the other side in the second direction W) is in contact with the substrate 50.

According to this configuration, since it is possible to reduce or prevent the rotation of the multilayer ceramic capacitor 10 about the first direction L, it is possible to easily maintain the mounting posture of the multilayer ceramic capacitor 10.

According to the present example embodiment, the substrate 50 includes the opening portion 55 including the opening 56 that is open on the first substrate surface SF1 and the inner peripheral surface 57, the multilayer ceramic capacitor 10 includes the capacitor-side counter surface 35 that is opposed to the inner peripheral surface 57 in the Z direction, and the inner peripheral surface 57 includes the substrate-side counter surface 58 that is opposed to the capacitor-side counter surface 35 in the Z direction.

According to this configuration, since it is possible to support the multilayer ceramic capacitor by the substrate-side counter surface, it is possible to reduce or prevent the movement of the multilayer ceramic capacitor 10 relative to the substrate 50 in the lamination direction T. In addition, it is possible to prevent the multilayer ceramic capacitor in the opening portion 55 from falling off of the substrate 50.

According to the present example embodiment, in the WT cross section the capacitor-side counter surface 35 includes the capacitor-side sloped surface 36 which is sloped with respect to the lamination direction T and the second direction W, and the substrate-side counter surface 58 includes the substrate-side sloped surface 59 which is sloped with respect to the lamination direction T and the second direction W.

According to this configuration, it is possible to narrow the back side (adjacent to the second substrate surface SF2) of the opening portion 55 while widening the opening 56 of the opening portion 55. By widening the opening 56, it is possible to easily insert the multilayer ceramic capacitor 10 into the opening portion 55. By narrowing the back side of the opening portion 55, it is possible to easily provide the multilayer ceramic capacitor 10 at a desired position. Therefore, it is possible to more easily manufacture the substrate-equipped multilayer ceramic capacitor 1.

Further, by narrowing the back side of the opening portion 55, it is possible to easily maintain the mounting posture of the multilayer ceramic capacitor 10.

According to the present example embodiment, in the WT cross section, the acute angle between the capacitor-side sloped surface 36 and the second direction W is more obtuse than the acute angle between the substrate-side sloped surface 59 and the second direction W.

According to this configuration, it is possible to make the dimension of the opening 56 in the second direction W larger than the dimension of the portion of the multilayer ceramic capacitor 10 to be inserted into the opening portion 55 in the second direction W. This makes it easier to insert the multilayer ceramic capacitor 10 into the opening portion 55.

According to the present example embodiment, in the WT cross section, the obtuse angle between the first surface F1 and the capacitor-side sloped surface 36 is about 110° or more and about 135°o r less.

This makes it possible to easily insert the multilayer ceramic capacitor 10 into the opening portion 55, and to easily maintain the mounting posture of the multilayer ceramic capacitor 10.

According to the present example embodiment, in the WT cross section, the acute angle between the capacitor-side sloped surface 36 and the second direction W is about 45° or more and about 70° or less, and the angle obtained by subtracting the acute angle between the second direction W and the substrate-side sloped surface 59 from the acute angle between the capacitor-side sloped surface 36 and the second direction W is greater than about 0° and equal to or less than about 5°.

According to this configuration, it is possible to easily insert the multilayer ceramic capacitor 10 into the opening portion 55, and it is possible to easily maintain the mounting posture of the multilayer ceramic capacitor 10.

According to the present example embodiment, the opening portion 55 penetrates the substrate 50 in the Z direction.

According to such a configuration, since it is possible to easily insert the multilayer ceramic capacitor deeper into the opening, it is possible to easily reduce the height of the substrate-equipped multilayer ceramic capacitor.

According to the present example embodiment, a portion of the external electrode 30 provided on the first surface F1 and the substrate 50 are separated from each other.

When the expansion and contraction vibration of the inner layer portion 21 is transmitted to the substrate 50, “acoustic noise” may occur. In a case where the dielectric layer 24 is made of a high dielectric constant material such as, for example, BaTiO, the expansion and contraction of the dielectric layer 24 due to the application of a voltage becomes relatively large, and therefore, acoustic noise easily occurs. However, according to such a configuration, since it is possible to reduce the contact area between the substrate 50 and the multilayer ceramic capacitor 10, it is possible to prevent the expansion and contraction vibration of the inner layer portion 21 from being transmitted to the substrate. In addition, by applying such a configuration to the multilayer ceramic capacitor 10 in which the dielectric layer 24 is made of a high dielectric constant material, it is possible to reduce or prevent the occurrence of noise while increasing the capacitance of the multilayer ceramic capacitor 10.

In addition, when stress is transmitted from the substrate 50 to the multilayer ceramic capacitor 10 when the substrate 50 is bent, structural defects such as cracks may occur in the multilayer body 20. However, according to such a configuration, it is possible to reduce or prevent the transmission of stress from the substrate 50 to the multilayer body 20. This makes it possible to reduce or prevent the occurrence of structural defects in the multilayer body 20.

### Second Example Embodiment

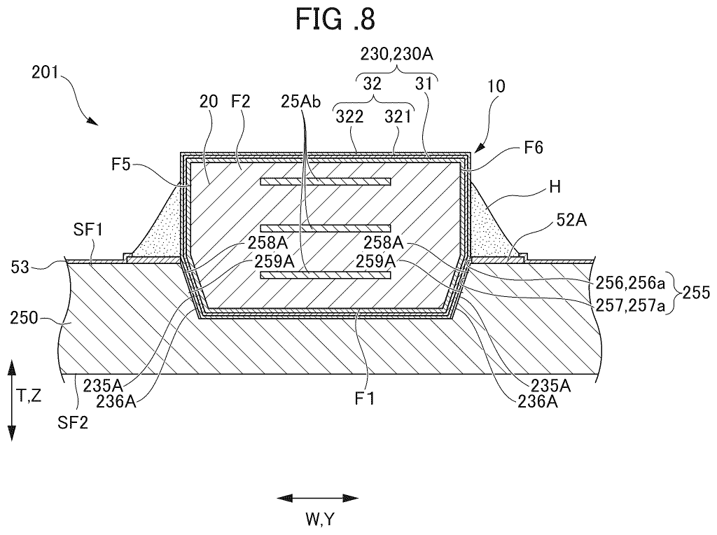

Hereinafter, a substrate-equipped multilayer ceramic capacitor 201 according to a second example embodiment of the present invention will be described with reference to FIG. 8. In the following description, differences between the multilayer ceramic capacitor 10 according to the first example embodiment and the multilayer ceramic capacitor 201 according to the second example embodiment will be mainly described. The same or corresponding components as those of the first example embodiment are denoted by the same reference numerals, and detailed descriptions thereof will be omitted.

The shape of the opening portion 255 of the substrate 250 of the second example embodiment is different from the shape of the opening portion 55 of the first example embodiment.

As shown in FIG. 8, the opening portion 255 includes a bottomed recessed shape that is open on the first substrate surface SF1 of the substrate 250. The opening portion 255 does not penetrate the substrate 250 in the Z direction. This makes it possible for the multilayer ceramic capacitor 210 to be prevented from slipping out of the substrate 250 through the opening portion 255. In addition, when the multilayer ceramic capacitor 210 is mounted on the substrate 250, it is possible to reduce or prevent the falling of the bonding material H through the opening portion 255.

In the cross section parallel or substantially parallel to the Y-direction and the Z-direction of the substrate 250, the inner peripheral surface 257 of the opening portion 255 includes, for example, a pair of lateral surface portions 257a that respectively extend from the opening 256 of the opening portion 255 to the intermediate portion of the substrate 250 in the Z-direction and are respectively sloped so as to approach the middle portion of the opening portion 255 in the Y direction approaching the second substrate surface SF2 from the first substrate surface SF1, and a bottom surface portion 257b that extends in the plane direction of the first substrate surface SF1 at the intermediate portion of the substrate 250 in the Z direction and connects the lateral surface portions. The internal space of the opening portion 255 as viewed in the X direction is a trapezoidal or substantially trapezoidal shape that tapers approaching the second substrate surface SF2 from the first substrate surface SF1.

The shape of the first external electrode 230A of the multilayer ceramic capacitor 10 of the second example embodiment is different from the shape of the first external electrode 30A of the first example embodiment.

When viewed in the first direction L, the first external electrode 230A includes a hexagonal or substantially a hexagonal shape in which a rectangle or substantially a rectangle is provided adjacent to the second surface F2 and an isosceles trapezoid or substantially an isosceles trapezoid narrowing toward the first surface F1 is provided adjacent to the first surface F1.

The outer surface of the portion of the first external electrode 230A provided on the fifth surface F5 includes two or more portions having different angles with respect to the lamination direction T and the second direction W when viewed in the first direction L. The outer surface of the portion of the first external electrode 230A provided on the fifth surface F5 extends, for example, from the second surface F2 toward the first surface F1 in parallel or substantially parallel with the lamination direction T, and further extends in a sloped manner so as to approach the middle portion of the multilayer body 220 in the second direction W approaching the first surface F1 from the second surface F2.

The outer surface of the portion of the first external electrode 230A provided on the sixth surface F6 includes two or more portions having different angles with respect to the lamination direction T and the second direction W when viewed in the first direction L. The outer surface of the portion of the first external electrode 230A provided on the sixth surface F6 extends, for example, from the second surface F2 toward the first surface F1 in parallel or substantially parallel with the lamination direction T, and further extends in a sloped manner so as to approach the middle portion of the multilayer body 220 in the second direction W approaching the first surface F1 from the second surface F2.

On the outer surface of the portion of the first external electrode 230A provided on the fifth surface F5, the portion that is sloped with respect to the lamination direction T and the second direction W is opposed to the inner peripheral surface 257 (the lateral surface portion 257a and the bottom surface portion 257b), and specifically is in contact with the inner peripheral surface 257. On the outer surface of the portion of the first external electrode 230A provided on the sixth surface F6, the portion that is sloped with respect to the lamination direction T and the second direction W is opposed to the inner peripheral surface 257 (the lateral surface portion 257a and the bottom surface portion 257b), and specifically is in contact with the inner peripheral surface 257.

Therefore, on the outer surface of the portion of the first external electrode 230A provided on the fifth surface F5, the portion that is sloped with respect to the lamination direction T and the second direction W is referred to as the first capacitor-side counter surface 235A. Further, the outer surface of the portion of the first external electrode 230A provided on the first surface F1 is referred to as the first capacitor-side counter surface 235A. In addition, on the outer surface of the portion of the first external electrode 230A provided on the sixth surface F6, the portion that is sloped with respect to the lamination direction T and the second direction W is also referred to as the first capacitor-side counter surface 235A. On the outer surface of the portion of the first external electrode 230A provided on the fifth surface F5, the portion that is sloped with respect to the lamination direction T and the second direction W is referred to as the first capacitor-side sloped surface 236A. Further, on the outer surface of the portion of the first external electrode 230A provided on the sixth surface F6, the portion that is sloped with respect to the lamination direction T and the second direction W is also referred to as the first capacitor-side sloped surface 236A.

In addition, the inner peripheral surface 257 includes a first substrate-side counter surface 258A that is opposed to the first capacitor-side counter surface 235A in the Z direction. Each of the lateral surface portions 257a and the bottom surface portion 257b defines and functions as the first substrate-side counter surface 258A. The first substrate-side counter surface 258A includes a first substrate-side sloped surface 259A that is sloped with respect to the lamination direction T and the second direction W. Each of the lateral surface portions 257a defines and functions as the first substrate-side sloped surface 259A.

The portion of the first external electrode 230A provided on the first surface F1 and the substrate 250 (specifically, the bottom surface portion 257b) are in contact with or immediately adjacent to each other. With such a configuration, it is possible to reduce or prevent the displacement of the multilayer ceramic capacitor 210 in the Z direction.

The shape of the multilayer body 220 of the second example embodiment as viewed in the first direction L is the same or substantially the same as, for example, the shape of the first external electrode 230A as viewed in the first direction L, which is similarly reduced. However, the shape of the multilayer body 220 as viewed in the first direction L is not limited thereto, and can be appropriately changed.

Although not shown, the configuration of the second external electrode 230B of the second example embodiment substantially corresponds to the configuration of the first external electrode 230 of the second example embodiment. However, the present invention is not limited thereto, and the configuration of the second external electrode 230B of the second example embodiment can be changed where appropriate.

### Modification Example of Example Embodiment

Although example embodiments of the present invention have been described above, the present invention is not limited to the above-described example embodiments, and various changes and modifications can be made.

In each of the above example embodiments, the shape of the multilayer body 20 in the WT cross section is the same as or similar to the shape of the external electrode 30 in the WT cross section. However, the present invention is not limited thereto. In the multilayer body 20, the dimension of the second surface F2 in the second direction W may be equal to or larger than the dimension of the first surface F1 in the second direction W. The shape of the multilayer body 20 in the WT cross section is not particularly limited, and may be rectangular or substantially rectangular.

In each of the above-described example embodiments, the shape of the multilayer body 20 in the WT cross section is the same or substantially the same over the entire or substantially the entire region of the multilayer body 20 in the first direction L. However, the present invention is not limited thereto. The dimension of the first surface F1 in the second direction W may not be smaller than the dimension of the second surface F2 in the second direction W over the entire or substantially the entire area of the multilayer ceramic capacitor 10 in the first direction L.

For example, the dimension of the first surface F1 in the second direction W may be smaller than the dimension of the second surface F2 in the second direction W in a portion of the multilayer body 20 where the external electrode 30 is provided, and the dimension of the first surface F1 in the second direction W may be greater than or equal to the dimension of the second surface F2 in the second direction W in a portion of the multilayer body 20 where the external electrode 30 is not provided. The multilayer body 20 including such a configuration is obtained, for example, by cutting a mother block to obtain multilayer chips each having a rectangular or substantially rectangular parallelepiped shape, and then forming a portion of each of the multilayer chips near an end portion thereof in the first direction L into a tapered shape by polishing or the like.

In each of the above-described example embodiments, the shape of each of the internal electrodes 25 as viewed in the lamination direction T is, for example, a rectangular or substantially rectangular shape. However, the present invention is not limited thereto. For example, in each of the first internal electrodes 25A, the minimum dimension of the first extension portion 25Ab in the second direction W may be smaller than the minimum dimension of the first counter portion 25Aa in the second direction W. For example, in the first internal electrode 25A, the first counter portion 25Aa may have a rectangular or substantially rectangular shape as viewed in the lamination direction T, and the first extension portion 25Ab may include a trapezoidal or substantially trapezoidal portion which is connected to the first counter portion 25Aa and whose shape as viewed in the lamination direction T becomes smaller in the dimension in the second direction W as being separated from the first counter portion 25Aa, and a rectangular or substantially rectangular portion which is connected to the third surface F3 and whose shape as viewed in the lamination direction T becomes smaller in the dimension in the second direction W than the first counter portion 25Aa. In addition, a dimension in the second direction W of a portion of the first counter portion 25Aa closer to the third surface F3 may be smaller than a dimension in the second direction W of a portion of the first counter portion 25Aa farther from the third surface F3.

By reducing the dimension in the second direction W of the first extension portion 25Ab, it is possible to easily maintain the distance between the first extension portion 25Ab and the outer surface of the multilayer body 20. With such a configuration, it is possible to reduce or prevent moisture from reaching the first extension portion 25Ab from the outside of the multilayer body 20, and thus it is possible to improve moisture resistance reliability. When a taper is provided on the outer surface of the portion of the multilayer body 20 where the external electrode 30 is provided, it is possible to easily maintain the distance between the outer surface of the multilayer body 20 and the first internal electrode 25A (the first extension portion 25Ab). The same applies to the second internal electrode 25B.

In addition, by increasing the dimension of the first counter portion 25Aa in the second direction W and the dimension of the second counter portion 25Ba in the second direction W, it is possible to increase the area where the internal electrodes 25 are opposed to each other. This makes it possible to increase the capacitance. Therefore, it is possible to improve the capacitance while improving moisture resistance reliability.

In addition, in at least one of the portion of the multilayer body 20 overlapping with the first extension portion 25Ab in the first direction L or the portion of the multilayer body 20 overlapping with the second extension portion 25Bb in the first direction L, the dimension in the second direction W of the first surface F1 may be smaller than the dimension in the second direction W of the second surface F2. Further, in the portion of the multilayer body 20 overlapping with the first counter portion 25Aa in the first direction L, the dimension in the second direction W of the first surface F1 may be equal to or larger than the dimension in the second direction W of the second surface F2. With such a configuration, it is possible to easily increase the dimension of the first counter portion 25Aa in the second direction W and the dimension of the second counter portion 25Ba in the second direction W, while reducing at least one of the dimension of the first extension portion 25Ab in the second direction W or the dimension of the second extension portion 25Bb in the second direction W. With such a configuration, it is possible to easily achieve the improvement in moisture resistance reliability and the improvement in capacitance.

The configuration of the external electrode 30 is not limited to those of the above example embodiments. For example, each of the external electrodes 30 may include a resin electrode layer.

The resin electrode layer is provided, for example, between the base electrode layer 31 and the first plated layer 321. The resin electrode layer may be provided directly on the multilayer body 20. The resin electrode layer is provided, for example, as a layer including electrically conductive particles and a thermosetting resin. The resin electrode layer may include a single layer or a plurality of layers.

The resin electrode layer can define and function as a cushion when the multilayer ceramic capacitor 10 placed inside the opening portion 55 is sandwiched by the substrate 50. Therefore, it is possible to relax the force transmitted from the substrate 50 to the multilayer ceramic capacitor 10 by the resin electrode layer. This makes it possible to reduce or prevent the occurrence of cracks in the multilayer ceramic capacitor 10.

In each of the above-described example embodiments, one substrate-equipped multilayer ceramic capacitor 1 includes one multilayer ceramic capacitor 10. However, the present invention is not limited thereto, and may include two or more multilayer ceramic capacitors 10. The dimensions of the substrate 50 of the substrate-equipped multilayer ceramic capacitor 1 in the X direction and the Y direction are not particularly limited. Electronic components other than the multilayer ceramic capacitor 10 may be attached to the substrate 50 of the substrate-equipped multilayer ceramic capacitor 1, or only the multilayer ceramic capacitor 10 may be attached thereto. The substrate of the substrate-equipped multilayer ceramic capacitor may be an interposer, for example. Since the multilayer ceramic capacitor is attached to another substrate different from the interposer via the substrate defining and functioning as the interposer, it is possible to reduce or prevent the transmission of vibration of the multilayer ceramic capacitor to the substrate different from the interposer. This makes it possible to reduce or prevent the occurrence of acoustic noise.

The configuration of the land 52 is not limited to those of the above example embodiments. The land 52 may extend into the opening portion 55. The configuration of the insulating film 53 is not limited to those of the above example embodiments. The insulating film 53 may extend into the opening portion 55. In addition, the capacitor-side counter surface 35 may be opposed to the inner peripheral surface 57 in the Z direction through some components such as for example, the land 52 and the insulating film 53. The substrate-side counter surface 58 may be opposed to the capacitor-side counter surface 35 in the Z direction through some components such as, for example, the land 52 and the insulating film 53.

In each of the above-described example embodiments, the shape of the opening 56 as viewed in the Z direction is a rectangular or substantially rectangular shape whose longitudinal direction is the X direction. However, the present invention is not limited thereto.

In each of the above-described example embodiments, the portions of the inner peripheral surface 57 opposed to each other in the Y direction are sloped with respect to the Y direction and the Z direction, but may extend parallel or substantially parallel to the Z direction. In this case, by fitting the multilayer ceramic capacitor 10 into the portions of the inner peripheral surface 57 opposed to each other in the Y direction, it is possible to reduce or prevent the multilayer ceramic capacitor 10 from rotating or falling off. The portions of the inner peripheral surface 57 opposed to each other in the Y direction may not be in contact with the multilayer ceramic capacitor 10.

In each of the above-described example embodiments, the portions of the inner peripheral surface 57 opposed to each other in the X direction extend parallel or substantially parallel to the Z direction, but may be sloped with respect to the Y direction and the Z direction. The portions of the inner peripheral surface 57 opposed to each other in the X direction may be in contact with the multilayer ceramic capacitor 10.

While example embodiments of the present invention and modifications thereof have been described above, it is to be understood that variations and modifications will be apparent to those skilled in the art without departing from the scope and spirit of the present invention. The scope of the present invention, therefore, is to be determined solely by the following claims.

What is claimed is:

1. A substrate-equipped multilayer ceramic capacitor comprising:
a multilayer ceramic capacitor; and
a substrate; wherein
the multilayer ceramic capacitor including:
a multilayer body including an inner layer portion including a plurality of dielectric layers and a plurality of internal electrodes laminated, a first surface and a second surface opposed to each other and each extending in parallel or substantially parallel with a lamination direction, a third surface and a fourth surface opposed to each other and each extending in a first direction orthogonal or substantially orthogonal to the lamination direction, and a fifth surface and a sixth surface opposed to each other and each extending in a second direction orthogonal or substantially orthogonal to the lamination direction and the first direction;
a first external electrode on the third surface and extending on the first surface, the second surface, the fifth surface, and the sixth surface; and
a second external electrode on the fourth surface and extending on the first surface, the second surface, the fifth surface, and the sixth surface; wherein
the substrate includes a first substrate surface and a second substrate surface opposed to each other in the lamination direction and on which the multilayer ceramic capacitor is mounted;
a dimension in the second direction of a portion of the first external electrode overlapping with the first surface as viewed in the lamination direction is smaller than a dimension in the second direction of a portion of the first external electrode overlapping with the second surface as viewed in the lamination direction;
a dimension in the second direction of a portion of the second external electrode overlapping with the first surface as viewed in the lamination direction is smaller than a dimension in the second direction of a portion of the second external electrode overlapping with the second surface as viewed in the lamination direction; and
the first surface and the second surface are located on opposite sides with the first substrate surface interposed therebetween.

2. The substrate-equipped multilayer ceramic capacitor according to claim 1, wherein
a portion of each of the first external electrode and the second external electrode on the fifth surface is in contact with the substrate; and
a portion of each of the first external electrode and the second external electrode on the sixth surface is in contact with the substrate.

3. The substrate-equipped multilayer ceramic capacitor according to claim 1, wherein
the substrate includes an opening portion including an opening open on the first substrate surface and an inner peripheral surface;
the multilayer ceramic capacitor includes a capacitor-side counter surface opposed to the inner peripheral surface of the opening portion in a direction orthogonal or substantially orthogonal to the substrate; and
the inner peripheral surface includes a substrate-side counter surface opposed to the capacitor-side counter surface in a direction orthogonal or substantially orthogonal to the substrate.

4. The substrate-equipped multilayer ceramic capacitor according to claim 3, wherein
in a cross section parallel or substantially parallel to the second direction and the lamination direction of the substrate-equipped multilayer ceramic capacitor, the capacitor-side counter surface includes a capacitor-side sloped surface sloped with respect to the lamination direction and the second direction, and the substrate-side counter surface includes a substrate-side sloped surface sloped with respect to the lamination direction and the second direction.

5. The substrate-equipped multilayer ceramic capacitor according to claim 4, wherein, in the cross section parallel or substantially parallel to the second direction and the lamination direction of the substrate-equipped multilayer ceramic capacitor, an acute angle between the capacitor-side sloped surface and the second direction is more obtuse than an acute angle between the substrate-side sloped surface and the second direction.

6. The substrate-equipped multilayer ceramic capacitor according to claim 4, wherein, in the cross section parallel or substantially parallel to the second direction and the lamination direction of the substrate-equipped multilayer ceramic capacitor, an obtuse angle between the first surface and the capacitor-side sloped surface is about 110° or more and about 135° or less.

7. The substrate-equipped multilayer ceramic capacitor according to claim 5, wherein, in the cross section parallel or substantially parallel to the second direction and the lamination direction of the substrate-equipped multilayer ceramic capacitor, an acute angle between the capacitor-side sloped surface and the second direction is about 45° or more and about 70° or less, and an angle obtained by subtracting an acute angle between the second direction and the substrate-side sloped surface from an acute angle between the capacitor-side sloped surface and the second direction is greater than about 0° and equal to or less than about 5°.

8. The substrate-equipped multilayer ceramic capacitor according to claim 3, wherein the opening portion penetrates the substrate in a direction orthogonal or substantially orthogonal to a direction in which the first substrate surface extends.

9. The substrate-equipped multilayer ceramic capacitor according to claim 1, wherein a portion of each of the first external electrode and the second external electrode on the first surface and the substrate are spaced apart from each other.

10. The substrate-equipped multilayer ceramic capacitor according to claim 2, wherein
the substrate includes an opening portion including an opening on the first substrate surface and an inner peripheral surface;
the multilayer ceramic capacitor includes a capacitor-side counter surface opposed to a inner peripheral surface of the opening portion in a direction orthogonal or substantially orthogonal to the substrate; and
the inner peripheral surface includes a substrate-side counter surface opposed to the capacitor-side counter surface in a direction orthogonal or substantially orthogonal to the substrate.

11. The substrate-equipped multilayer ceramic capacitor according to claim 1, wherein the multilayer body has a quadrangular or substantially quadrangular columnar shape.

12. The substrate-equipped multilayer ceramic capacitor according to claim 10, wherein, in a cross section parallel or substantially parallel to the second direction and the lamination direction of the substrate-equipped multilayer ceramic capacitor, the capacitor-side counter surface includes a capacitor-side sloped surface sloped with respect to the lamination direction and the second direction, and the substrate-side counter surface includes a substrate-side sloped surface sloped with respect to the lamination direction and the second direction.

13. The substrate-equipped multilayer ceramic capacitor according to claim 12, wherein, in the cross section parallel or substantially parallel to the second direction and the lamination direction of the substrate-equipped multilayer ceramic capacitor, an acute angle between the capacitor-side sloped surface and the second direction is more obtuse than an acute angle between the substrate-side sloped surface and the second direction.

14. The substrate-equipped multilayer ceramic capacitor according to claim 12, wherein, in the cross section parallel or substantially parallel to the second direction and the lamination direction of the substrate-equipped multilayer ceramic capacitor, an obtuse angle between the first surface and the capacitor-side sloped surface is about 110° or more and about 135° or less.

15. The substrate-equipped multilayer ceramic capacitor according to claim 13, wherein, in the cross section parallel or substantially parallel to the second direction and the lamination direction of the substrate-equipped multilayer ceramic capacitor, an acute angle between the capacitor-side sloped surface and the second direction is about 45° or more and about 70° or less, and an angle obtained by subtracting an acute angle between the second direction and the substrate-side sloped surface from an acute angle between the capacitor-side sloped surface and the second direction is greater than about 0° and equal to or less than about 5°.

16. The substrate-equipped multilayer ceramic capacitor according to claim 10, wherein a portion of each of the first external electrode and the second external electrode on the first surface and the substrate are spaced apart from each other.

17. The substrate-equipped multilayer ceramic capacitor according to claim 2, wherein a portion of each of the first external electrode and the second external electrode on the first surface and the substrate are spaced apart from each other.
